(19) United States
(12) Patent Application Publication
(10) Pub. No.: US 2014/0331613 A1
(43) Pub. Date: Nov. 13, 2014

(54) PACKAGING METHOD, PACKAGING APPARATUS AND INJECTION-MOLDING INSTALLATION HAVING A PACKAGING APPARATUS

(71) Applicant: Waldorf Technik GmbH & Co. KG, Engen (DE)

(72) Inventors: Wolfgang Czizegg, Steisslingen (DE); Werner Jaiter, Steisslingen (DE)

(73) Assignee: Waldorf Technik GmbH & Co. KG, Engen (DE)

(21) Appl. No.: 14/272,631

(22) Filed: May 8, 2014

(30) Foreign Application Priority Data
May 8, 2013 (DE) 10 2013 104 800.5

(51) Int. Cl. B29C 45/42; B65B 5/10

(52) U.S. Cl. CPC B29C 45/42; B65B 5/105
USPC 53/448; 425/165; 53/543

(57) ABSTRACT

The invention relates to a packaging method and to a packaging apparatus by which plastic injection moldings designed in the form of pipette tips or medical reaction vessels are packaged in end packaging units. The invention provides for the operation of distributing the K plastic injection moldings over the sub-groups to take place in the at least one end packaging unit exclusively during the operation of filling the end packaging unit, and for plastic injection moldings to be distributed over the sub-groups until the at least one end packaging unit has been filled completely with in each case A plastic injection moldings.

### BACKGROUND OF THE INVENTION

The invention relates to a packaging method according by means of which injection moldings which are designed in the form of pipette tips or medical reaction vessels are packaged, and to a packaging apparatus by means of which plastic injection moldings which are designed in the form of pipette tips or medical reaction vessels are packaged. The invention also relates to an injection-molding installation having such a packaging apparatus.

In the case of known packaging methods by means of which plastic injection moldings which are designed in the form of pipette tips or medical reaction vessels, in particular for blood analysis, are packaged, plastic injection moldings are removed simultaneously from K cavities of an injection-molding apparatus and are stored on an interim basis in the form of bulk material. End packaging units are then each loaded with A plastic injection moldings from said interim stores. The disadvantage with the known method is that packaged plastic injection moldings are not associated in any way with certain cavities. It is therefore no longer possible to ascertain clearly the cavity or cavities from which the plastic injection moldings of a certain end packaging unit originate. Even in the case of just a single defective plastic injection molding in an end packaging unit, this results in the entire production run having to be recalled, rather than just the end packaging units filled with plastic injection moldings from a certain cavity or from certain cavities.

A packaging method which has improved in relation to the problem outlined above provides for the plastic injection moldings which are designed in the form of pipette tips or medical reaction vessels to be transferred from the cavities into the end packaging units directly without being set down in an interim store, i.e. without being stored on an interim basis. For this purpose, the plastic injection moldings are conveyed to the end packaging units via hoses. The disadvantage here is that the number A of plastic injection moldings which can be delivered in an end packaging unit have to correspond to the number K of cavities, or that the number A of plastic injection moldings which can be transferred in an end packaging unit has to be a whole-numbered multiple of the number K of cavities. It is particularly disadvantageous that such an installation requires a vast amount of space for the hose arrangement and its cycle time is comparatively slow.

A packaging method which is improved in relation to the aforementioned problem, and an associated packaging apparatus, is described by the applicant in EP 2 323 930 B1. The improved method provides for the K plastic injection moldings removed simultaneously from the K cavities to be set down simultaneously in an interim store in a distributed state over U sub-groups, and for K plastic injection moldings to be removed from the K cavities, and distributed over the U sub-groups in the interim store, repeatedly until each sub-group has L plastic injection moldings, wherein the number L of plastic injection moldings of a sub-group corresponds to the maximum number A of plastic injection moldings which can be loaded in an end packaging unit or to a whole-numbered devisor of A. This method has proven successful, but attempts are being made to improve the cycle times of the packaging method by means of which plastic injection moldings which are designed in the form of pipette tips or medical reaction vessels are packaged.

WO 2004/054778 A1 describes an apparatus for packaging injection moldings in end packs, wherein the plastic injection moldings are set down in a horizontal set-down plane by a robot arm with corresponding gripping tools.

### SUMMARY OF THE INVENTION

Proceeding from the aforementioned prior art, it is an object of the invention to indicate a packaging method, by means of which plastic injection moldings which are designed in the form of pipette tips or medical reaction vessels are packaged, which is optimized in terms of cycle time as well as a correspondingly improved packaging apparatus and an injection-molding installation having such a packaging apparatus, wherein the method is intended to ensure that it is possible to ascertain clearly the cavity or cavities from which the plastic injection moldings of an end packaging unit originate, it being possible for the maximum number A of plastic injection moldings which can be loaded in an end packaging unit to be selected independently of the fixed number K of cavities of an injection mold. Furthermore, the construction of the apparatus should be as straightforward and robust as possible and, in addition, the risk of damage to the plastic injection moldings should be minimized.

This object is achieved, in respect of the packaging method, the packaging apparatus and the injection-molding installation as disclosed herein. Advantageous developments of the invention are also indicated. The invention covers all combinations of at least two features disclosed in the description, the claims and/or the figures.

In order to avoid repetition, features which are disclosed in relation to the method should also count as being disclosed in relation to the apparatus and should be claimable as such. Likewise, features which are disclosed in relation to the apparatus should count as being disclosed in relation to the method and should be claimable as such.

The invention is based on the concept of dispensing with an interim store for forming the sub-groups, said interim store being used in the known method comprising a set-down gripper, and instead of forming the sub-groups directly, by means of a set-down gripper, simultaneously and in a single end packaging unit or, as an alternative, simultaneously and preferably in a plurality of end packaging units. In other words, the single end packaging unit is, or the plurality of end packaging units are, filled in steps by simultaneously K plastic injection moldings being distributed over the sub-groups in the single end packaging unit or in the plurality of end packaging units repeatedly, in succession. In this case, following a removal and/or a set-down operation, plastic injection moldings are distributed over the sub-groups in the single end packaging unit or the plurality of end packaging units until each end packaging unit has been filled with A plastic injection moldings, i.e. the maximum possible number of articles which can be inserted into the same. As will also be explained at a later stage in the text, the operation of distributing the plastic injection moldings over the sub-groups can take place without the plastic injection moldings being set down beforehand, for example by the plastic injection moldings being transferred from the K cavities into the end packaging units directly by means of a removal gripper for removing the K injection moldings or, as an alternative, by means of a transfer gripper, which receives the plastic injection moldings directly from a removal gripper, or by means of a further transfer gripper, which receives the articles from at least one transfer gripper. The set-down gripper is thus formed preferably either by the removal gripper or by a transfer gripper. It is also possible, and preferred, for the K plastic injection moldings to be buffer-stored in a buffer store, wherein the buffer store accommodates preferably exclusively the K plastic injection moldings from a single injection shot, rather than a large number of K injection moldings from a plurality of injection shots. The plastic injection moldings can be set down in the buffer store by means of the removal gripper or preferably by means of a transfer gripper. The set-down operation in the end packaging unit(s) then takes place by way of the set-down gripper, by means of which preferably the plastic injection moldings are also removed from the buffer store.

It is possible, in principle, for the number of end packaging units which can be filled with plastic injection moldings simultaneously by means of a set-down gripper to correspond to the number K of cavities. In this case, the end packaging units are filled in a cavity-specific manner, i.e. each end packing unit is given a single sub-group preferably having plastic injection moldings from a single cavity. However, it is also possible, and preferred, for fewer end packaging units to be filled simultaneously than there are cavities present. In this case, each end packaging unit is preferably given the same number of sub-groups, preferably in each case at least two sub-groups, wherein the at least two sub-groups each end packaging unit are increased simultaneously, during a set-down step, by in each case at least one, preferably exclusively one, plastic injection molding. In the extreme case, it is conceivable for just a single end packaging unit to be filled simultaneously—in which case said end packaging unit is then given all the plastic injection moldings from all the cavities during each set-down step. It is preferred, however, if at least two end packaging units are filled simultaneously, i.e. if the groups in at least two end packaging units are formed and/or increased simultaneously until the end packaging units have been filled completely in each case with the maximum possible number A of plastic injection moldings.

The plastic injection moldings are set down one beside the other in each case in a, preferably horizontal set-down plane in the end packaging units, wherein it is particularly preferred if, in the case of a plurality of end packaging units being filled simultaneously, said end packaging units are arranged in a common plane or form a common set-down plane.

By dispensing with the plastic injection moldings being grouped into sub-groups, each comprising a plurality of plastic injection moldings, in an interim store, the apparatus as a whole can be realized in a more straightforward and cost-effective manner. By dispensing with the hose arrangements which are used in other known methods and by using at least one set-down gripper, preferably a plurality of grippers, instead, the construction is further simplified and the risk of damage to the plastic injection moldings is minimized. Furthermore, drift, which is disadvantageous in medical applications, is avoided.

The essential factor is for the packaging units in which the sub-groups are formed to be end packaging units which, once filled completely, are delivered to end users, wherein the delivery steps to the end users, or transfer to a haulier or similar means of transport, is a method step according to a development, which, hereby, should count as being disclosed in claimable form. The end packs here are preferably dimensioned such that they contain either 32, 48, 60, 84, 96, 105 or 120 plastic injection moldings. The end packaging units are preferably delivered to the end users in external packaging, wherein either the end packs are provided individually, i.e. each, with external packaging or, as an alternative, a plurality of end packs are grouped and provided together with external packaging, for example with an external carton or a sheet-material pack. The end packs used are expressly not interim-storage workpiece carriers, from which end packaging units are then packaged in a later step, in particular following a storage period in an interim store. It is also the case that the end packs are not constituted by an interim store which rotates within the packaging apparatus and/or remains in the same, like the interim store which is described in EP 2 323 930 B1, the end packaging units then being filled therefrom.

The essential factor, therefore, is that the end packs do not remain permanently, and thus, for example, rotate, in the packaging apparatus; rather they are fed to the packaging process by suitable feeding means and, following the loading operation, are discharged from the packaging apparatus by suitable discharging means.

Each end packaging units preferably comprises a carrier, for example made of plastic or metal, having a plurality of openings each for accommodating a plastic injection molding. These carriers are, quite particularly preferably, metallic carriers, for example made of aluminum, which are produced in a highly precise manner and, after having been used as intended by the end user, in particular in an analyzer, can pass back in an empty state to the packaging process and be refilled again. In addition, or as an alternative, to the in each case A openings or depressions, the end packaging units may have A plug-on elements, on which the plastic injection moldings can be plugged.

As an alternative, the end packaging units may be disposable carriers, e.g. made of plastics. Irrespective of the material selected for the carrier, these are preferably designed, and intended, to be used in an analyzer, in particular in a blood analyzer. The carriers are preferably coordinated with known analyzers such that they can be inserted into the same, in which case the analyzers can remove pipette tips or medical reaction vessels, preferably automatically, from the carrier.

The method designed in accordance with the concept of the invention is ideally used when the number A of plastic injection moldings which is to be provided for each end packaging unit does not speak to the number of cavities or to a whole-numbered multiple of the number of cavities.

There are different options relating to the number of end packaging units which are filled with (in each case exclusively) A plastic injection moldings, by the sub-groups being formed in the end packaging units. It is thus conceivable for just a single end packaging unit to be filled simultaneously until it contains A plastic injection moldings, in which case a plurality of end packaging units are then preferably filled with in each case A plastic injection moldings one after the other. As an alternative, it is possible for a plurality of end packaging units to be filled with plastic injection moldings simultaneously until each of these end packaging units contains A plastic injection moldings. If just a single end packaging unit is filled simultaneously, then this end packaging unit forms a set-down plane. For the case where a plurality of end packaging units are filled simultaneously, said end packaging units preferably form a, preferably horizontal, set-down plane together.

As already indicated in the introduction, it is possible for the K plastic injection moldings to be transferred into the single end packaging unit, or simultaneously into a plurality of end packaging units, without being set down briefly in a buffer store defining a set-down plane, in particular a horizontal plane. This can be realized, albeit while accepting comparatively long cycle times, by transfer to the sub-groups taking place by means of a removal gripper (which is then the same as the set-down gripper), by way of which the plastic injection moldings are removed from the cavities. It is preferred, however, if the K plastic injection moldings are transferred from the removal gripper to a transfer gripper and are set down by the latter, or a further transfer gripper, in the single packaging unit or in the plurality of packaging units, in which case the set-down gripper is then a transfer gripper.

As an alternative, it is possible, and preferred from the point of view of further speed optimization, for the K plastic injection moldings to be buffer-stored in a buffer store prior to being distributed over the U sub-groups in the single end packaging unit or in the plurality of end packaging units, wherein the buffer store is preferably dimensioned and/or activated such that exclusively one injection shot's worth of K plastic injection moldings is buffer-stored therein, wherein the buffer storage can take place, as an alternative, using the removal gripper or preferably by means of a transfer gripper, by means of which the plastic injection moldings are received from the removal gripper. The set-down operation in the end packaging unit(s) then takes place preferably by means of a set-down gripper.

In a quite particularly preferred manner, provision is made, in accordance with a development, for it to be possible for the buffer store to be adjusted, e.g. in a translatory or rotary manner, between a loading position, in which it is loaded with an injection shot's worth of K plastic injection moldings, and a removal position, in which the plastic injection moldings are removed by means of a gripper, in particular the set-down gripper (or a transfer gripper for transfer to the set-down gripper), and are distributed over the U sub-groups in the single end packaging unit or the plurality of packaging units. It is quite particularly preferred here if the removal of the plastic injection moldings from the interim store takes place using exclusively a vertical movement, wherein it is further preferred if, following removal and prior to the single end packaging unit or the plurality of end packaging units being loaded, the buffer store shifts again from the removal position in the direction of the loading position.

It is particularly expedient if the plastic injection moldings from a certain cavity are always assigned to a certain sub-group, in order for it to be possible for the production run to be ascertained in optimal fashion. For the case where a sub-group is filled, simultaneously or successively, from a plurality of cavities, it is advantageous if this relationship remains consistent and for it to be possible at least to state the cavities from which the plastic injection moldings of an end packaging unit originate and thus, in the event of defects, for it to be possible to confine a search and to be necessary to recall just certain, correspondingly identified packaging units.

It is particularly expedient if each sub-group, following each removal cycle, is always increased by the same number of plastic injection moldings, preferably by a single plastic injection molding, wherein it is also possible to realize an embodiment in which the number of plastic injection moldings which can be transferred in a sub-group fluctuates from set-down cycle to set-down cycle.

It is particularly expedient if the sub-groups are depicted and/or set down as a cohesive unit in the individual end packaging unit or the plurality of end packaging units, the plastic injection moldings of a sub-group thus being arranged in a fixed position relative to one another. It is quite particularly preferred if it is possible to identify the sub-groups in the single end packaging unit or the plurality of end packaging units, and this can be realized by the sub-groups being spaced apart from one another, although this is not imperative. The essential factor is for a control unit to identify the position of the plastic injection moldings belonging to a certain sub-group. It is thus possible, in principle, for a plurality of plastic injection moldings of different sub-groups to be arranged directly one beside the other.

The invention also leads on to a packaging apparatus which is preferably designed for implementing a packaging method configured as described above. The packaging apparatus comprises removal means for simultaneously removing K plastic injection moldings from K cavities. The packaging apparatus also comprises set-down means which comprise a set-down gripper and are designed for simultaneously setting down the K plastic injection moldings, in a uniformly distributed state over U sub-groups, wherein, in the simplest case, the set-down means are formed by the removal means. It is also possible to provide separate removal means and set-down means, and this scenario is the preferred one. The packaging apparatus also comprises feeding means for feeding end packaging units to the packaging process, and discharging means for discharging filled packaging units from the packaging apparatus, in particular in order for it to be possible for the end packaging units to be fed to an external-packaging apparatus.

The packaging apparatus also comprises a control unit for activating the removal means and/or the set-down means, wherein the control unit is designed to activate the removal means and/or the set-down means such that K plastic injection moldings are removed from the K cavities, and distributed uniformly over the U sub-groups, repeatedly until each sub-group has L plastic injection moldings, wherein the number L of plastic injection moldings of a sub-group corresponds to the maximum number A of plastic injection moldings which can be accommodated in an end packaging unit or to a whole-numbered devisor of A. Furthermore, the control means are designed such that they activate the removal means and/or the set-down means such that a single end packaging unit is filled with A plastic injection moldings, or that a plurality of end packaging units are each filled with A plastic injection moldings simultaneously, wherein the A plastic injection moldings are set down in the single end packaging unit or in the plurality of end packaging units in a common, in particular horizontal set-down plane. The invention, then, provides for the control unit to be designed to activate the set-down means such that the latter groups the K plastic injection moldings into the sub-groups in the single end packaging unit exclusively during the operation of filling the end packaging unit, or in the plurality of packaging units exclusively during the operation of filling the end packaging units, i.e. expressly not in an interim store; rather, the end packaging units are each loaded with a plurality of sub-groups, comprising plastic injection moldings, without the plastic injection moldings being pre-grouped, wherein the operation of increasing the sub-groups takes place in the end packaging unit(s). If appropriate, in each case a single injection shot's worth of K cavities is buffer-stored in a buffer store, which is then likewise part of the packaging apparatus. The control unit, furthermore, activates the set-down operation such that the single end pack or the plurality of end packs is/are filled completely with in each case A plastic injection moldings.

A gripper, e.g. a removal gripper, a transfer gripper or a set-down gripper, within the context of the invention is understood to mean, in addition to mechanical grippers, so-called vacuum grippers, which attach the plastic injection moldings by means of negative pressure and thus retain and/or grip the same.

There are different options relating to the design of the feeding and/or discharging means. A particularly preferred embodiment is one involving, at least in part, combined feeding and discharging means comprising, for example, a common transporting belt or a jointly rotatable table, wherein, in the case of a rotatable table being provided, the latter can be used to transport a single end packaging unit, or simultaneously a plurality of packaging units, to a loading position for loading by means of the set-down gripper and, once the end packaging unit or units has/have been filled completely in each case with A plastic injection moldings, to rotate the same out of the loading position and thus discharge the same from the packaging apparatus. If appropriate, the packaging units are fed from the turntable back to the delivery belt. It is also conceivable for the single end packaging unit or the plurality of end packaging units to be filled directly on a transporting belt or, following a filling operation, rather than being conveyed on a delivery belt, to be conveyed on a different, removal or discharging belt. It is also possible to provide circulating workpiece carriers in the form of for example combined feeding and/or discharging means, the end packaging units being transported temporarily thereon, wherein the end packs are positioned in an empty state on the workpiece carriers and are removed therefrom again in the filled state, in particular by means of a gripper.

The invention also leads on to an injection-molding installation having an injection-molding apparatus with K cavities for simultaneously producing K plastic injection moldings, wherein the injection-molding installation, in particular the injection mold, is designed for producing plastic injection moldings which are designed in the form of pipette tips or medical reaction vessels, that is to say the injection-molding installation has a mold appropriate for this purpose. The injection-molding installation comprises at least one, preferably exclusively one, packaging apparatus designed as described above. It is also possible, in principle, to operate a plurality of packaging apparatuses parallel to one another, wherein preferably each packaging apparatus is assigned a dedicated injection-molding apparatus.

### BRIEF DESCRIPTION OF THE DRAWINGS

Further advantages, features and details of the invention can be gathered from the following description of preferred exemplary embodiments and with reference to the drawings, in which:

FIG. 1 shows an injection-molding apparatus having an injection mold which, in the exemplary embodiment shown, has a fixed number of K=16 cavities for simultaneously producing K plastic injection moldings designed in the form of pipette tips or medical reaction vessels,

FIGS. 2a and 2b show four end packaging units following in each case a different number of set-down cycles, wherein, in the exemplary embodiment shown, two sub-groups (as an alternative just a single group or more than two sub-groups) are produced in each end packaging unit, these sub-groups being increased by a respective plastic injection molding during each set-down cycle, or following each removal cycle, i.e. following each injection shot, and

FIGS. 3a to 3e show an injection-molding installation having an injection-molding apparatus and a packaging apparatus, in different operating states, a complete packaging cycle for filling an end packaging unit being shown over the course of FIGS. 3a to 3e.

Like elements and elements of like function are identified in the figures using like designations.

### DETAILED DESCRIPTION

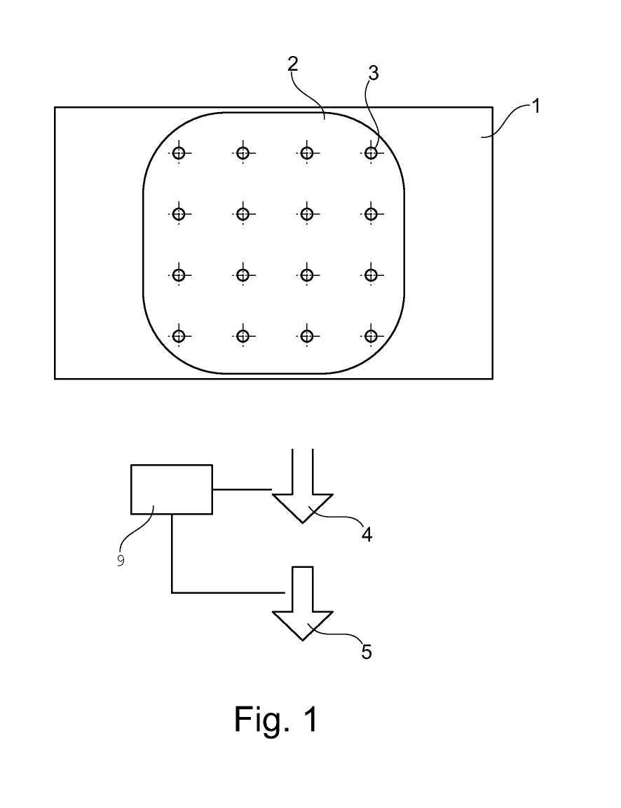

FIG. 1 shows, as part of an injection-molding installation, an injection-molding apparatus 1, comprising an injection mold 2, having K=16 cavities 3 for simultaneously producing K=16 plastic injection moldings 8 which are designed in the form of pipette tips or medical reaction vessels.

The injection-molding apparatus 1 is assigned removal means 4 which are designed for example in the form of suction grippers, preferably with a number of suction elements which correspond to the number K of cavities, said removal means being indicated merely in stylized form as an arrow and being part of a packaging apparatus (not designated). In the exemplary embodiment shown, the removal means 4 serve exclusively for removing the injection moldings 8 from the cavities 3, wherein the injection moldings 8 removed by the removal means 4 are transferred to a transfer gripper of set-down means 5, which then directly set down the injection moldings and simultaneously group them into sub-groups in the end packaging units. The transfer gripper, in this case, forms the set-down gripper according to the invention. As an alternative, it is possible for the plastic injection moldings 8 to be set down in the first instance in a buffer store by the removal means 4, or a transfer gripper assigned thereto, it being preferred if the buffer store, once loaded with the plastic injection moldings 8, shifts to a set-down gripper of set-down means, which then remove the injection moldings 8 from the buffer store and transfer them in grouped form into the end packaging units. The removal means 4, the set-down means and any additional transfer means which may possibly be provided preferably each comprise at least one gripper, wherein the gripper, yet further preferably, has a number of gripping devices which corresponds to the number K of cavities. The grippers may be designed in the form of mechanical grippers and/or of negative-pressure grippers.

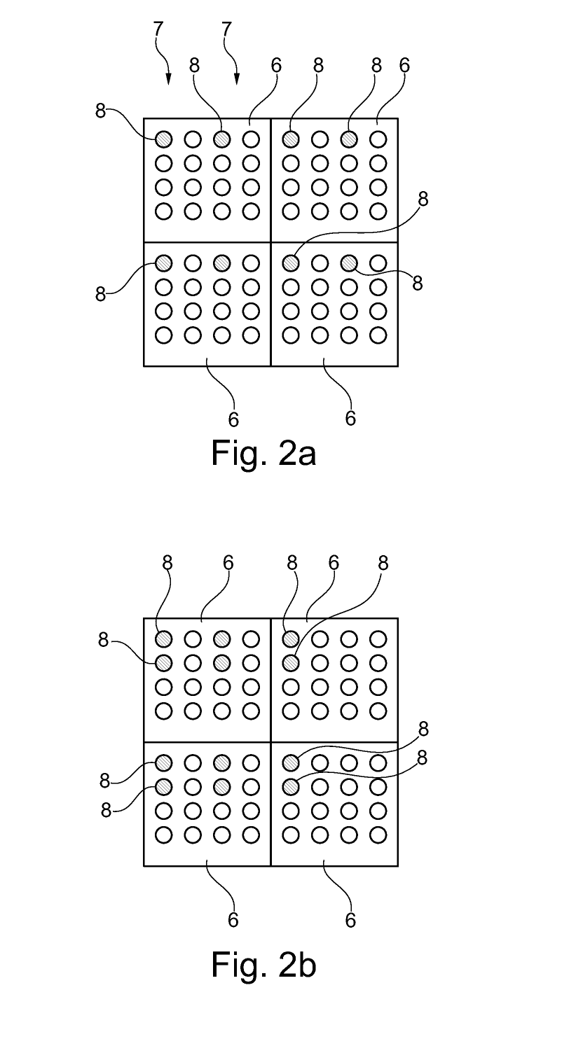

FIGS. 2a and 2b each illustrate four end packaging units 6 which are being filled simultaneously during each set-down step. In the exemplary embodiment shown, each end packaging unit has A=16 set-down locations for accommodating at most A=16 plastic injection moldings 8, wherein A (instead of 16) may also be any other whole number. In the exemplary embodiment shown, the task is for each end packaging unit 6 to be filled with in each case U=two sub-groups 7 of plastic injection moldings 8, wherein each sub-group 7, in the exemplary embodiment shown, should be cavity-specific, i.e. should contain plastic injection moldings just from a certain cavity. In the exemplary embodiment shown, each sub-group comprises L=eight plastic injection moldings 8. In order for the end packs 6 to be filled completely, it is therefore necessary to have a total of eight removal and set-down cycles if, during each set-down cycle, each sub-group 7 is increased by one plastic injection molding 8 and two plastic injection moldings 8 are set down simultaneously for each end packaging unit 6. FIG. 2a here shows the filling station following a single set-down cycle, and FIG. 2b shows the filling station following two successive set-down cycles. It is expressly not the case that the plastic injection molding 8 has been pre-grouped in an interim store. The invention dispenses with such an interim store. Instead, the grouping operation takes place directly in the end packs 6 with the aid of set-down means 5 comprising a gripper.

All the end packaging units 6, as described above, each have to be filled with a plurality of cavity-specific sub-groups 7. For this purpose, a control unit 9, which is indicated in FIG. 1, correspondingly activates the removal means 4 and the set-down means 5 and, if appropriate, an additionally provided transfer gripper for filling a buffer store, which, in the event of the latter being of adjustable design, can be activated correspondingly likewise by the control unit 9.

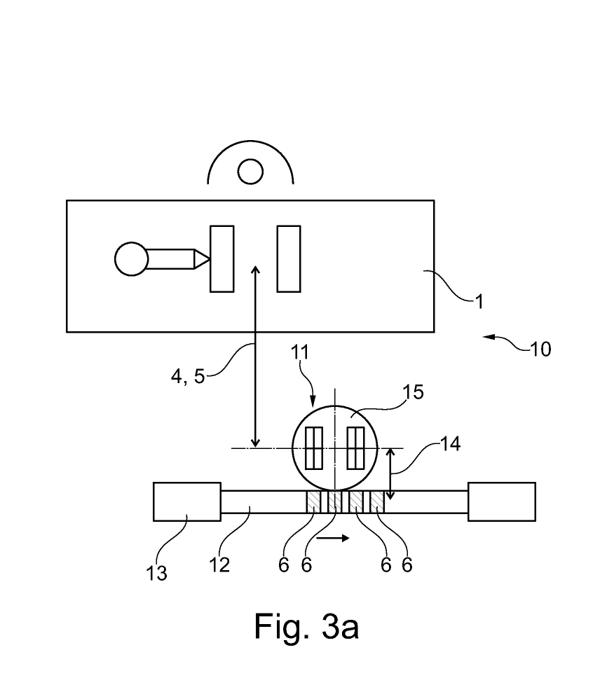

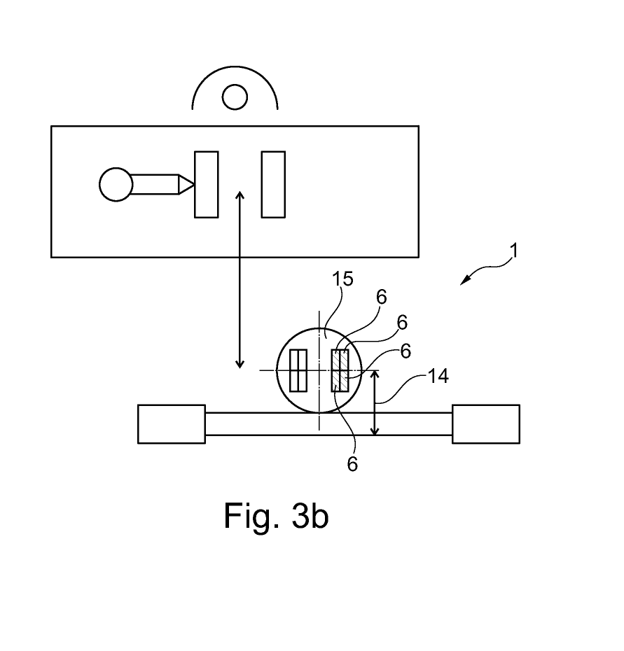

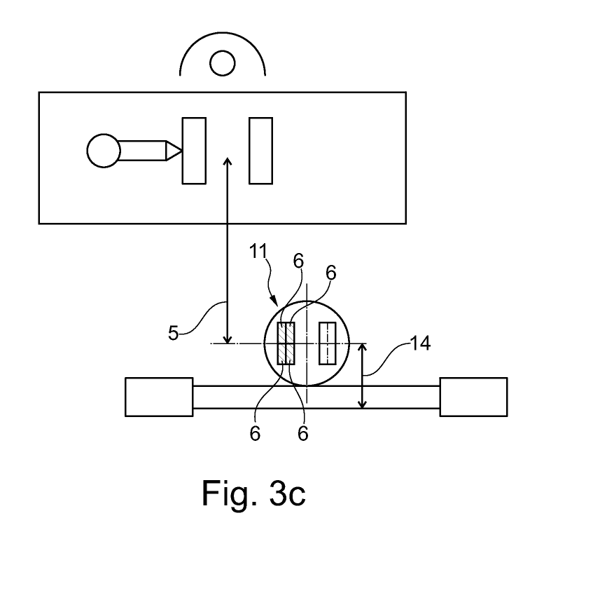

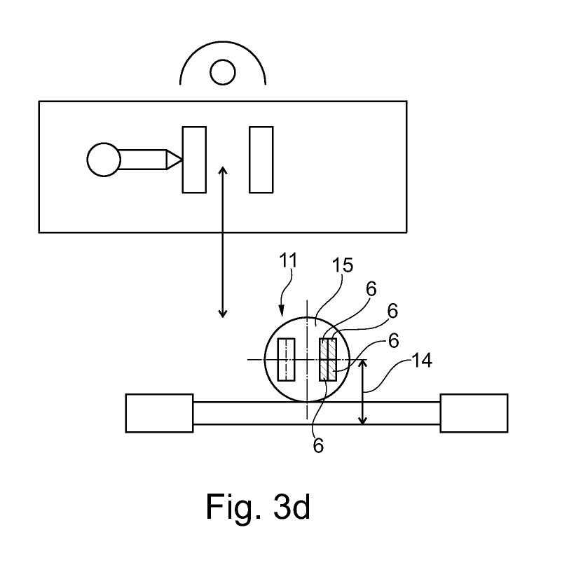

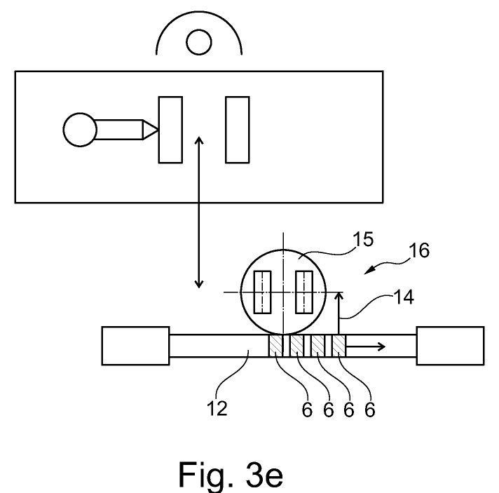

FIGS. 3a to 3e illustrate the step-by-step sequence for filling end packaging units 6 using the example of an entire injection-molding installation 10, comprising a packaging apparatus 16. It is possible to see injection-molding apparatus 1, from which injection moldings are removed and grouped into sub-groups in the end packs, if appropriate (not illustrated) with in each case just a single injection shot's worth being buffer-stored in a buffer store. The operations of removing the plastic injection moldings 8 from the cavities and setting them down in the end packaging units 6 take place using removal means 4 and set-down means 5.

In order for it to be possible for end packaging units 6 to be filled, with the aid of the set-down means 5, in groups of plastic injection moldings 8, the latter have to be conveyed to a loading position 11, in which they are then filled into the end packaging units by means of the set-down gripper (suction gripper and/or mechanical gripper) of the set-down means. Provided for this purpose, in the first instance, is a delivery belt 12, on which, in the exemplary embodiment shown, in the first instance six empty end packaging units 6 are delivered from a store 13. The four as yet empty end packaging units 6 are transported on a turntable 15 by way of a transfer device 14, wherein the loading position 11, as an alternative, can also be approached directly by means of a conveying belt. FIG. 3b, then, shows that the four empty end packaging units 6 have been transferred onto the turntable 15. The latter, then, is rotated, for example through 180° in the exemplary embodiment shown, so that, as can be seen from FIG. 3c, the four as yet empty end packaging units 6 pass into the loading position 11, in which they can be filled with the aid of the set-down means 5. Once the four end packaging units 6 have been filled completely, they are rotated back again, by virtue of the turntable 15 being rotated, into the starting position according to FIG. 3b, from which they are set back again, with the aid of the transfer gripper 14, on the conveying belt 12, which, at the same time, is a discharging belt, as can be seen from FIG. 3e. The filled end packaging units 6 are then discharged in a suitable manner from the packaging apparatus 16.

FIGS. 3a to 3e illustrate the end packaging units 6, merely for demonstration purposes, as being spaced apart on the conveying belt. They are preferably transported up such that they can be removed together by means of the transfer gripper 14 and can also be set back again together on the conveying belt 12. It is also conceivable to provide different conveying belts 12 for transporting the empty end packs up and for transporting the filled end packs away or to provide a conveying belt for transporting-up purposes or, as an alternative, a conveying belt for transporting-away purposes, in which case the operations of transporting up or away are realized with the aid of other suitable transporting means, for example with the aid of grippers. The essential factor is for empty end packaging units to be fed to the packaging process using suitable feeding means and, once filled, to be discharged from the packaging apparatus 1 again by suitable discharging means. It is also the case that the preferred turntable 15 should be considered as being purely optional for this purpose and it can also be used without conveying belts 12, or it is also possible to dispense with the turntable 15, for example by the end packaging units, filled on a conveying belt, being transported away again by the latter conveying belt or some other conveying belt. It is also possible to dispense completely with the turntable 15 and/or the conveying belt 12, by providing a suitable robotic handling unit, for example with the aid of at least one gripper.

1. Packaging method by means of which plastic injection moldings (8) which are designed in the form of pipette tips or medical reaction vessels are packaged in end packaging units (6), comprising the following steps:
simultaneously removing K plastic injection moldings from K cavities (3),
simultaneously setting down the K plastic injection moldings (8), in a uniformly distributed state over U sub-groups (7), with the aid of set-down means (5) comprising a gripper,
removing K injection moldings from the K cavities (3), and uniformly distributing the K injection moldings over the U sub-groups (7), repeatedly until each sub-group (7) has L plastic injection moldings (8), wherein the number L of plastic injection moldings (8) of a sub-group (7) corresponds to the maximum number A of plastic injection moldings (8) which can be accommodated in an end packaging unit (6) or to a whole-numbered devisor of A,
filling at least one end packaging unit (6) with A plastic injection moldings (8), wherein the operation of setting down the A plastic injection moldings (8) in the at least one end packaging unit (6) takes place in a set-down plane, wherein the operation of distributing the K plastic injection moldings (8) over the sub-groups (7) takes place in the at least one end packaging unit (6) exclusively during the operation of filling the end packaging unit, and wherein plastic injection moldings (8) are distributed over the sub-groups (7) until the at least one end packaging unit (6) has been filled completely with in each case A plastic injection moldings (8).

2. Packaging method according to claim 1, wherein the set-down plane is horizontal.

3. Packaging method according to claim 1, wherein simultaneously K end packaging units (6) are each filled with a single sub-group (7) having L=A plastic injection moldings (8), or wherein at least two sub-groups (7) are filled simultaneously in each packaging unit.

4. Packaging method according to claim 1, wherein the K plastic injection moldings (8) are removed from the K cavities (3) by means of a removal gripper and are set down in the at least one end packaging unit (6), in a distributed state over the sub-groups (7), by means of the removal gripper or by means of a transfer gripper (14), by way of which the K plastic injection moldings (8) are received from the removal gripper, or by means of a further transfer gripper (14), without being set down on an interim basis in a buffer store.

5. Packaging method according to claim 4, wherein the buffer store is horizontal.

6. Packaging method according to claim 1, wherein the K plastic injection moldings (8), are buffer-stored in a buffer store prior to being distributed over the U sub-groups (7).

7. Packaging method according to claim 6, wherein the K plastic injection moldings (8), together with the buffer store, is adjusted between a loading position (11), in which the buffer store is loaded preferably with exclusively K plastic injection moldings (8), and a removal position, in which the buffer store is emptied in order for the K plastic injection moldings (8) to be distributed over the U sub-groups (7).

8. Packaging method according to claim 6, wherein the K plastic injection moldings (8) are removed from the K cavities (3) by means of a removal gripper and are set down in the buffer store by means of the removal gripper or by means of a transfer gripper (14), by way of which the K plastic injection moldings (8) are received from the removal gripper, or by means of a further transfer gripper, and/or in that the buffer store, prior to the removal of the K plastic injection moldings (8) and prior to the at least one end packaging unit (6) being loaded, is adjusted, in particular in a translatory or rotary manner, from the removal position in the direction of the loading position (11).

9. Packaging method according to claim 1, wherein the end packaging unit(s) (6) is/are designed such that it/they can be used in an analyzer designed in the form of a blood analyzer.

10. Packaging method according to claim 1, wherein the end packaging unit(s) (6) to be filled with in each case A plastic injection moldings (8) is/are packaged individually or in groups in external packaging.

11. Packaging method according to claim 10, wherein the external packaging is an external carton and/or a sheet material pack.

12. Packaging method according to claim 1, wherein the end pack(s) (6) has/have a respective carrier part having A openings or having A plug-on elements for accommodating the A injection moldings.

13. Packaging method according to claim 1, wherein the plastic injection moldings (8) from a certain cavity (3) or from certain cavities (3) are always set down in a certain sub-group (7) or in certain sub-groups (7), wherein each sub-group (7) comprises exclusively plastic injection moldings (8) from a single cavity (3).

14. Packaging method according to claim 1, wherein each sub-group (7), during each set-down cycle, is always increased by the same number of plastic injection moldings (8), by a single injection molding.

15. Packaging method according to claim 1, wherein the number A corresponds to a whole-numbered multiple of the number of cavities or does not correspond to a whole-numbered multiple of the number of cavities.

16. Packaging method according to claim 1, wherein simultaneously only a single end packaging unit is filled with plastic injection moldings and the sub-groups are formed in the single end packaging unit, or wherein simultaneously a plurality of end packaging units are filled with plastic injection moldings and the sub-groups are formed in the plurality of end packaging units.

17. Packaging apparatus (16) by means of which plastic injection moldings (8) which are designed in the form of pipette tips or medical reaction vessels are packaged in end packaging units (6) designed for implementing a packaging method according to claim 1, comprising:
removal means (4) designed for simultaneously removing K plastic injection moldings (8) from K cavities (3),
set-down means (5) comprising a set-down gripper and designed for simultaneously setting down the K plastic injection moldings (8), in a uniformly distributed state over U sub-groups (7),
feeding means for feeding empty end packaging units (6), and discharging means for discharging filled end packaging units (6) from the packaging apparatus (16),
control means for activating the removal means (4) and/or the set-down means (5), the control means being designed to activate these such that
K injection moldings can be removed from the K cavities (3), and can be distributed uniformly over the U sub-groups (7), repeatedly until each sub-group (7) has L plastic injection moldings (8), wherein the number L of plastic injection moldings (8) of a sub-group (7) corresponds to the maximum number A of plastic injection moldings (8) which can be accommodated in an end packaging unit (6) or to a whole-numbered devisor of A,
and such that at least one end packaging unit (6) can be filled with A plastic injection moldings (8), wherein the A plastic injection moldings (8) can be set down in the at least one end packaging unit (6) in a preferably common, in particular horizontal, set-down plane,
wherein the control means are designed to activate the set-down means (5) such that the operation of distributing the K plastic injection moldings (8) over the sub-groups (7) takes place in the at least one end packaging unit (6) exclusively during the operation of filling the end packaging unit (6), and such that plastic injection moldings (8) are distributed over the sub-groups (7) until the at least one end pack has been filled completely with A plastic injection moldings (8).

18. Packaging apparatus according to claim 17, wherein the feeding means and/or the discharging means comprise at least one transporting belt and/or at least one rotatable table, by means of which the end packs can be conveyed in the empty state to a loading position (11), at which said end packs are loaded in each case with the A plastic injection moldings (8), and/or by means of which the filled end packs and can be discharged from the packaging apparatus (16).

19. Injection-molding installation having an injection-molding apparatus (1), with K cavities (3) for simultaneously producing K as pipette tips or medical reaction vessels, and having a packaging apparatus (16) according to claim 17.

20. Injection-molding installation according to claim 19, wherein the packaging apparatus (16) has arranged downstream of it an external-packaging apparatus, by means of which the end packs filled by means of the packaging apparatus (16) can be packaged individually or in groups in external packaging made of paperboard or plastic.
